(19) United States
(12) Patent Application Publication
(10) Pub. No.: US 2005/0089063 A1
(43) Pub. Date: Apr. 28, 2005

(54) Computer system and control method thereof

(76) Inventors: Takaaki Haruna, Tokyo (JP); Yuzuru Maya, Sagamihara (JP); Masaya Ichikawa, Sagamihara (JP); Hideaki Sanpei, Tokyo (JP)

Correspondence Address: MATTINGLY, STANGER & MALUR, P.C., SUITE 370, 1800 DIAGONAL ROAD, ALEXANDRIA, VA, 22314, US

(21) Appl. No.: 10/969,959

(22) Filed: Oct. 22, 2004

(30) Foreign Application Priority Data
Oct. 24, 2003 (JP) 2003-364816

(51) Int. Cl. H04L 12/28; H04J 3/16; H04J 3/22; H04L 1/00; H04J 1/16; H04J 3/14

(52) U.S. Cl. 370/468; 370/252

(57) ABSTRACT

A computer system includes servers that receive messages sent from respective terminals, perform handlings associated with the received messages, and reallocate resources along with a variation in load deriving from the reception of the messages. The computer system comprises: an input counting unit that classifies the messages received from the respective terminals on the basis of an input classification table, and transmits messages, which are classified into each category, as time-sequential input information; and a resource control unit that predicts a minimum usage of each resource on the basis of the time-sequential input information, time-sequential load information representing a change in load on each resource, and load prediction rules in which a predicted value of a variation in load occurring in a server in a predetermined time due to the reception of messages is recorded.

### BACKGROUND OF THE INVENTION

1. Field of the Invention

The present invention relates to a computer system in which computer resources must be reallocated along with a variation in load. In particular, the present invention is concerned with an optimal method of allocating the resources.

2. Description of the Related Art

As far as recent computer systems are concerned, the load on a computer system rapidly increases under specific conditions including a user-specific situation and a market movement, or in other words, in the cases of shopping on the Web, transaction on a stock exchange, and online banking. On this occasion, a response time increases or the system may go down. On the other hand, it is not cost-efficient to make sufficient computer resources available all the time in case of a temporary increase in load. There is a demand for a mechanism of avoiding degradation of a service level caused by a sharp variation in load.

Known as one of such mechanisms is a method of adding resources if necessary or releasing resources, which are not needed any longer, in preparation for any other purpose (for example, HotRod Demo. released from IBM Corp.).

In the above case, a server periodically manages past load information as time-sequential information, predicts load using the time-sequential information and pre-prepared rules, and validates or invalidates auxiliary hardware if necessary.

### SUMMARY OF THE INVENTION

According to the foregoing related art, the server periodically manages past load information as time-sequential information, predicts load using the time-sequential information and pre-prepared rules, and validates or invalidates auxiliary hardware if necessary.

In order to appropriately predict load according to a specific function or algorithm, it is necessary to designate parameters properly. The designation is time-consuming. Moreover, even if the parameters are thus designated, they may soon become useless due to a change in an environment.

In order to solve the above problems, a mode described below is proposed.

Specifically, a computer system includes a server that receives messages sent from respective terminals, performs handlings associated with the received messages, and reallocates resources along with a variation in load deriving from the reception of messages. Herein, the computer system comprises: an input counting means for classifying the messages received from the respective terminals on the basis of an input classification table, and transmitting messages, which are classified into each category, as time-sequential input information; and a resource control means for predicting a minimum usage of each resource according to the time-sequential input information, time-sequential load information that represents a change in load on each resource, and load prediction rules in which a predicted value of a variation in load occurring in the server in a predetermined time due to the reception of messages is recorded.

### BRIEF DESCRIPTION OF THE DRAWINGS

FIG. 1 is an explanatory diagram showing the configuration of a computer system;

FIG. 2 is an explanatory diagram showing the flows of information in the computer system;

FIG. 3 is an explanatory diagram concerning input classification information;

FIG. 4 is an explanatory diagram concerning time-sequntial load information;

FIG. 5 is an explanatory diagram showing the format of time-sequential information on input messages;

FIG. 6 is an explanatory diagram showing the software configuration of a server system;

FIG. 7 is an explanatory diagram describing a process to be followed by an input counting facility;

FIG. 8 is an explanatory diagram describing a process to be followed by a resource control facility;

FIG. 9 is an explanatory diagram describing a process to be followed by a system configuration modification feature;

FIG. 10 is an explanatory diagram describing a process to be followed by a load prediction rule correction feature;

FIG. 11 is an explanatory diagram concerning a process to be followed when the load on CPUs increases along with increase in the number of input messages;

FIG. 12 is an explanatory diagram concerning a process to be followed when the load on CPUs decreases along with a decrease in the number of input messages;

FIG. 13 is concerned with an example of a process to be followed in a configuration, in which one computer is divided into a plurality of logical computers, when the load on CPUs increases along with an increase in the number of input messages;

FIG. 14 is an explanatory diagram concerning a process to be followed in a configuration, in which one computer is divided into a plurality of logical computers, when the load on CPUs decreases along with a decrease in the number of input messages;

FIG. 15 is concerned with a process to be followed in a computer system, which comprises a plurality of computers, when the load on CPU increases along with an increase in the number of input messages; and

FIG. 16 is an explanatory diagram concerning a process to be followed in the computer system, which comprises a plurality of computers, when the load on CPUs decreases due to a decrease in the number of input messages.

### DESCRIPTION OF THE PREFERRED EMBODIMENTS

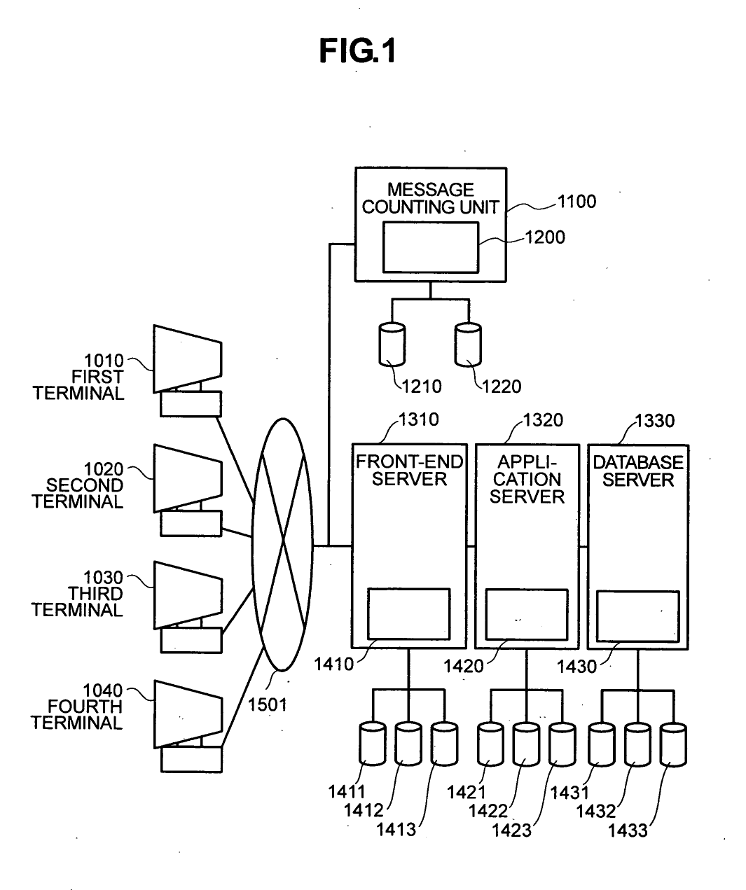

FIG. 1 is an explanatory diagram concerning the configuration of a computer system. The computer system comprises first to fourth terminals 1010 to 1040, a message counting unit 1100, a network 1501, a front-end server 1310 that manages the input/output interface with users, an application server 1320 that implements service logic, and a database server 1330 that manages data required for providing services.

The message counting unit 1100 is connected to the first to fourth terminals 1010 to 1040 and connected to the front-end server 1310 over the network 1501. The message counting unit 1100 includes an input counting facility 1200 (which will be detailed later), and can access the input classification information 1210 and time-sequential input information 1220 that are stored in external storage devices 1210 and 1220. Incidentally, hereinafter, what is referred to as a facility will be a software program to be run by a processor included in each unit. Alternatively, the facilities may be realized as dedicated hardware devices. Noted is that although each of the facilities may be described as an entity that performs an action, the processor that runs the facility (program) or the dedicated hardware realizing the facility actually performs the action.

The front-end server 1310 includes a resource control facility 1410 (which will be detailed later), and can access time-sequential load information 1411, load prediction rules 1412, and a configuration modification history 1413 that are stored in external storage devices. Likewise, the application server 1320 includes a resource control facility 1420, and can access time-sequential load information 1421, load prediction rules 1422, and a configuration modification history 1423. Similarly, the database server 1330 includes a resource control facility 1430 and can access time-sequential load information 1431, load prediction rules 1432, and a configuration modification history 1433.

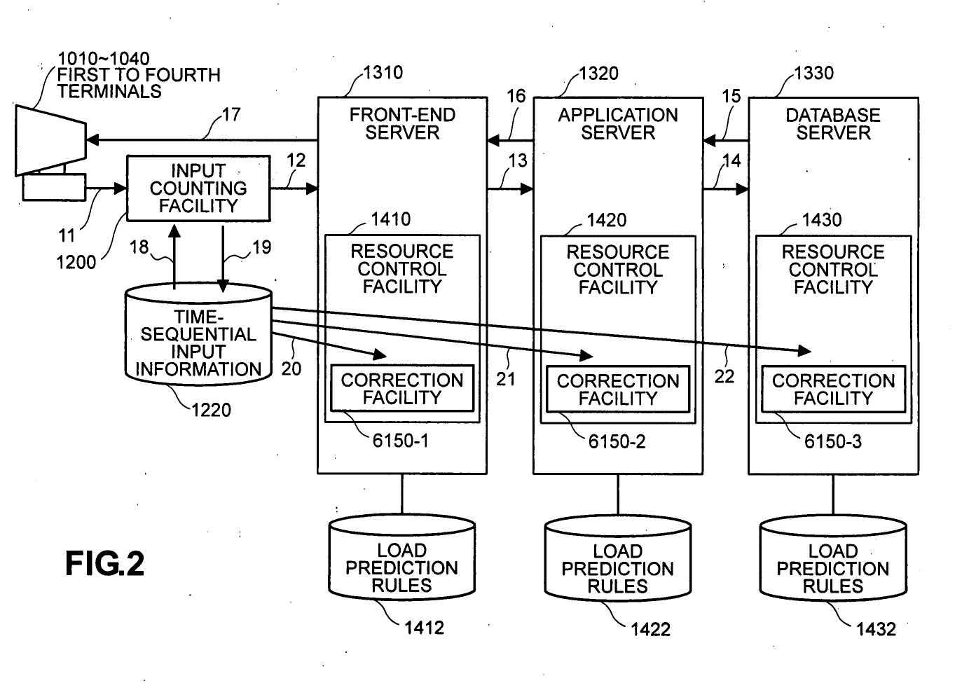

FIG. 2 is an explanatory diagram showing the flows of information in the computer system. Referring to FIG. 2, the flows of information 11 to 28 indicate movements of information occurring along with the flow of processing.

The input counting facility 1200 counts the number of user entries 11 made at the terminals 1010 to 1040. The input counting facility 1200 references past time-sequential input information 18, which is recorded in the time-sequential input information 1220, and additionally registers the information 19 on the new entries.

Moreover, the user entries 11 are transferred as messages 12, of which formats are held intact, to the front-end server 1310, and then handled. When the front-end server 1310 handles the messages, the front-end server 1310 transfers, if necessary, a request 13 to the application server 1320. When the application server 1320 handles the messages, the application server 1320 transfers, if necessary, a request 14 to the database server 1330. The results 15 of handling of the messages by the database server 1330 are returned to the application server 1320. The results 16 of handling of the messages by the application server 1320 are returned to the front-end server 1310. The results of handling of the messages by the front-end server 1310 are transmitted as responses 17 to the respective terminals 1010 to 1040. While these message handlings are executed, the loads on the servers 1310, 1320, and 1330 vary.

The resource control facility 1410 included in the front-end server 1310 predicts a load value to be imposed on the system in the future on the basis of the time-sequential load information 1411 and the load prediction information 20 recorded in the time-sequential input information 1220. For the prediction of the load, the front-end server 1310 uses the dedicated load prediction rules 1412. Based on the results of the prediction, the resource control facility 1410 modifies the usages of resources included in the front-end server 1310. The resource control facility 1410 verifies whether the modification of the usages of resources has been made appropriately. Based on the result of the verification, the load prediction rules 1412 are corrected.

Incidentally, the resource control facility 1420 included in the application server 1320 and the resource control facility 1430 included in the database server 1330 reference and handle data in the same manner as the resource control facility 1410 included in the front-end server 1310 does.

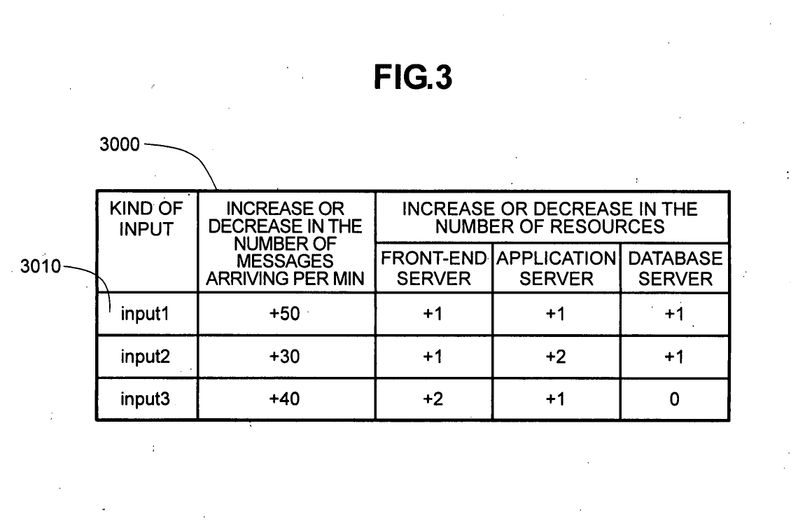

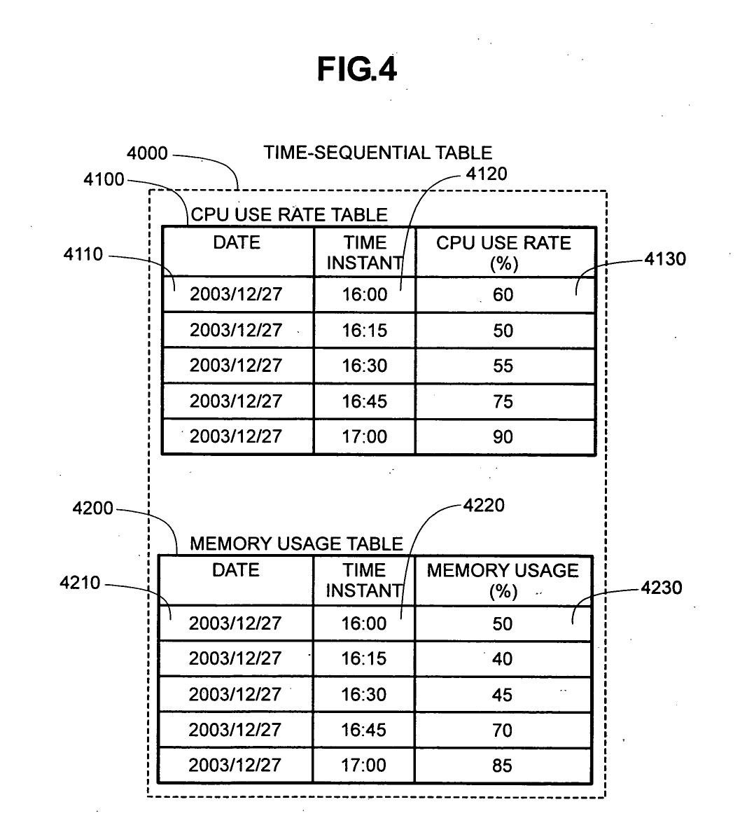

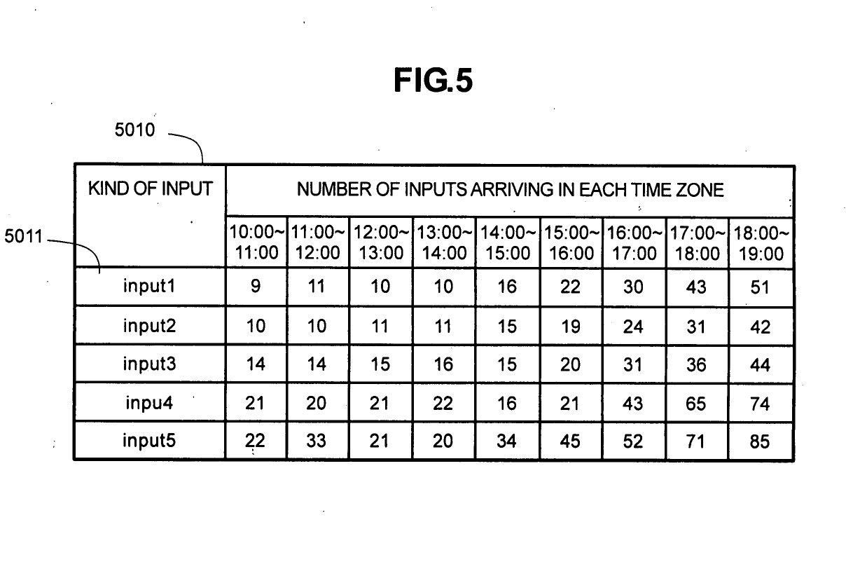

Next, referring to FIG. 3, FIG. 4, and FIG. 5, the contents of information to be handled by the computer system in accordance with the present embodiment will be described below.

FIG. 3 is an explanatory diagram concerning input message classification information. An input message classification table 3000 indicates the relationship of correspondence between a kind of input message and the servers 1310, 1320, and 1330 whose loads are affected by the reception of the input message. The input message classification table 300 lists combinations 3010 each including the kind of input message, an increase or a decrease in the number of messages of the kind arriving per minute, and an increment in the number of resources required by each of the servers.

FIG. 4 is an explanatory diagram concerning time-sequential load information. A time-sequential table 4000 is a table in which a time-sequential change in load is recorded in relation to each kind of load. Herein, a CPU use rate table 4100 indicating a time-sequential change in a CPU use rate and a memory usage table 3200 indicating a time-sequential change in a memory usage are presented as examples.

The CPU use rate table 4100 comprises a column for a date 4110, a column for a time instant 4120, and a column for a load value (CPU use rate) 4130. Likewise, the memory usage table 4200 comprises a column for a date 4210, a column for a time instant 4220, and a column for a load value (memory usage) 4230.

FIG. 5 is an explanatory diagram concerning the format of time-sequential information on input messages.

A table 5010 listing time-sequential information indicates a transition of the number of arriving messages per unit time for each kind of input message. The time-sequntial information table 5010 comprises rows 5011 each including a kind of input message and the numbers of messages arriving during respective time zones of one hour long.

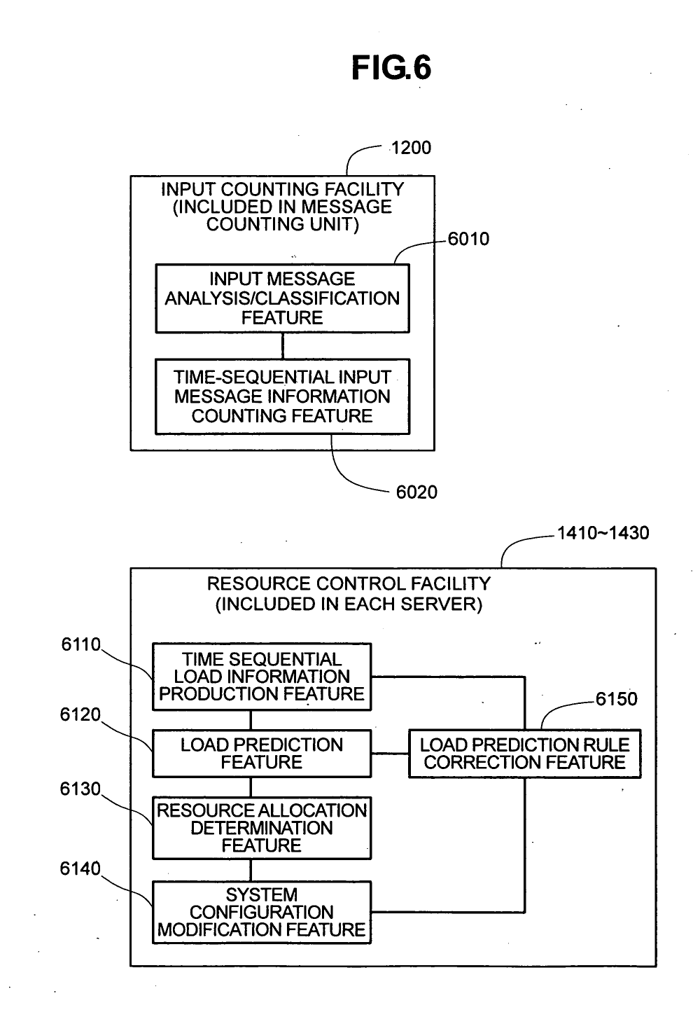

FIG. 6 is an explanatory diagram showing the software configurations of the message counting unit and the server system respectively. The input counting facility 1200 includes an input message analysis/classification feature 6010 and a time-sequential input message information counting feature 6020.

The input message analysis/classification feature 6010 analyses and classifies input messages. The time-sequential input message information counting feature 6020 counts the number of messages of each kind, and records the count values as the time-sequential information 1220 like the one shown in FIG. 5.

The resource control facility 1410, 1420, or 1430 included in the server 1310, 1320, or 1330 comprises a time-sequential load information production feature 6110, a load prediction feature 6120, a resource allocation determination feature 6130, a system configuration modification feature 6140 for reallocation of resources, and a load prediction rule correction feature 6150.

The time-sequential load information production feature 6110 collects, counts, records pieces of server load information, and produces the time-sequential load information shown in FIG. 3. The load prediction feature 6120 predicts an amount of load to be imposed on a server in the future. The resource allocation determination feature 6130 determines usages of resources required for treating the predicted amount of load to be imposed on a server. The system configuration modification feature 6140 modifies a system configuration so as to allocate required usages of resources. The load prediction rule correction feature 6150 evaluates the result of prediction performed by the load prediction feature 6120, and, if necessary, corrects the load prediction rules 1412, 1422, or 1432.

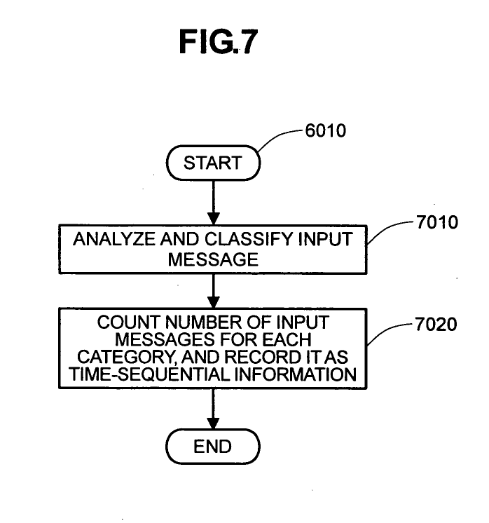

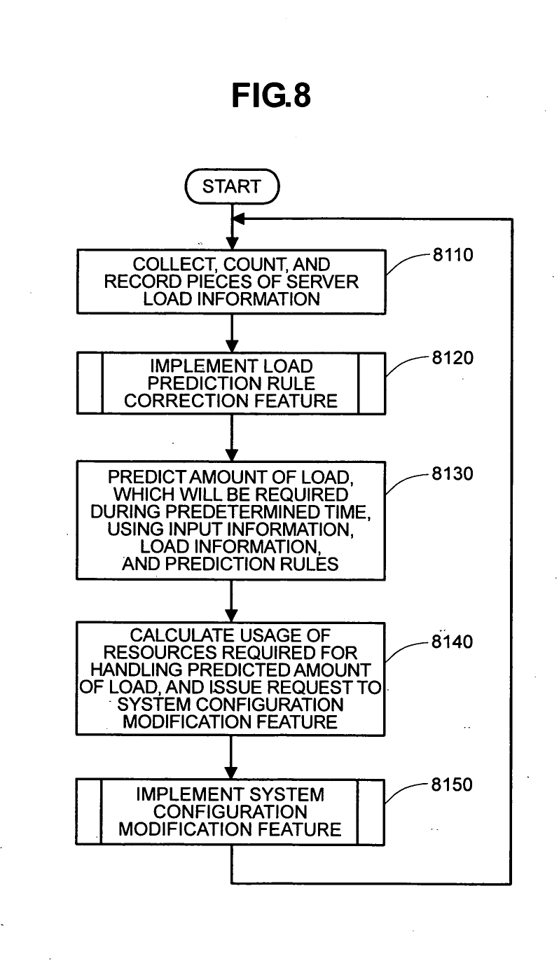

Next, referring to FIG. 7 and FIG. 8, a description will be made of a process of controlling a resource use rate at which the server 1310, 1320, or 1330 uses resources so as to maintain a satisfactory service level.

Referring to FIG. 1 that shows the configuration of the computer system, the message counting unit 1100 analyses a message, that is, a request input according to a terminal protocol or any other communication conventions, and decomposes the message into elements (step 7010). Thereafter, the message counting unit 1100 classifies the input message on the basis of the result of the analysis and the input classification information 1210 (step 7020). The input classification information 1210 has contents analogous to the contents of the input message classification table 3000 shown in FIG. 3, and indicates the relationship of correspondence between a kind of input message and a server whose load is affected by the reception of the input message. Incidentally, the input classification information 1210 is prepared in advance before the system is started up.

Finally, the message counting unit 1100 counts the number of input messages for each category, and records the count values together with the request input time instants in the time-sequential input information 1220 in the same manner as that shown in FIG. 5 (step 6020).

FIG. 8 is an explanatory diagram describing a process to be followed by the resource control facility 1410, 1420, or 1430. The flow of processing steps will be described in relation to the resource control facility 1410, 1420, or 1430 included in the front-end server 1310, application server 1320, or database server 1330.

Resource control flows to be followed by the three servers 1310, 1320, and 1330 are identical to one another. Hereinafter, the resource control flow will be described by taking the resource control facility 1410 included in the front-end server for instance.

To begin with, load information on the front-end server 1310 is collected and recorded in the time-sequential information 1411 as shown in FIG. 4 (step 8110).

When resource control has been extended through load prediction in the past, the load prediction rule correction feature 6150 is used to correct the load prediction rules 1412 (step 8120).

Thereafter, based on the time-sequential input information 1220 shown in FIG. 5, the time-sequential load information 1411 shown in FIG. 4, and the load prediction rules 1412, a predicted value of a minimum usage of each of the resources included in the system which will be required during a predetermined time interval (for example, within thirty minutes from now on) is calculated. The front-end server 1310 receives the time-sequential input information from the message counting unit 1100 at any time (step 8130).

Thereafter, usages of resources required for treating the predicted load are calculated, and a request for the usages of resources is issued to the resource control facility 1410 (step 8140).

The system configuration modification feature modifies the system configuration so as to meet the request (step 8150).

Hereinafter, the foregoing steps (steps 8110 to 8150) are repeated in order to extend control for retaining the usages of resources at appropriate values.

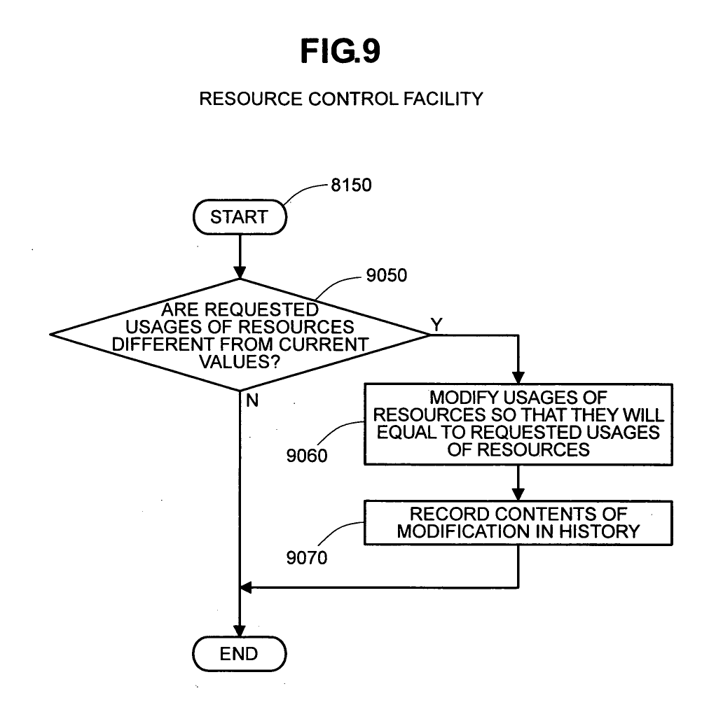

FIG. 9 is an explanatory diagram describing a process to be followed by the system configuration modification feature 6140.

First, the usages of resources presented to the system configuration modification feature 6140 are compared with the current usages of the resources included in the system (step 9050).

If the usages of resources disagree with the current usages thereof, the system configuration is modified so that it will match the calculated usages of resources (step 9060). The contents of the modification are recorded in the configuration modification history 1413 (step 9070).

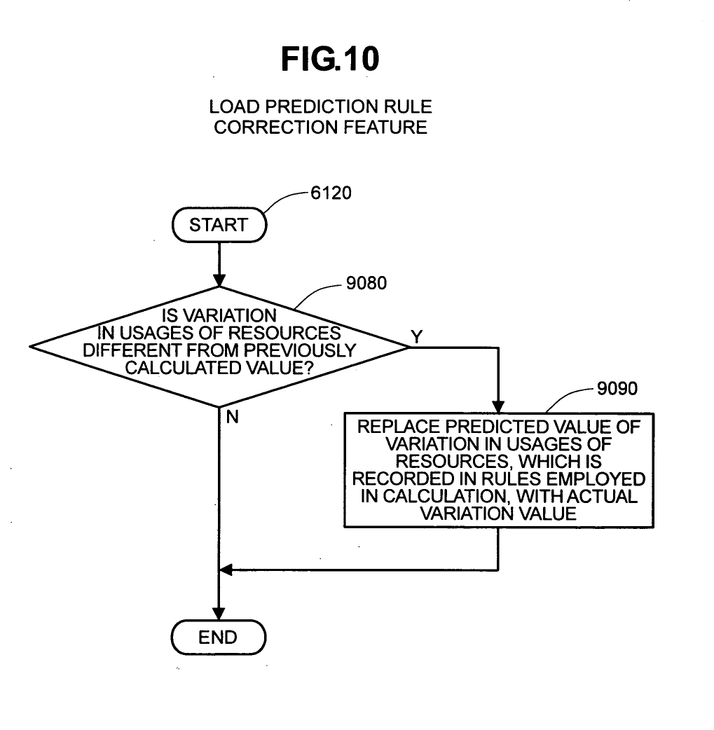

FIG. 10 is an explanatory diagram describing a process to be followed by the load prediction rule correction feature 6150.

First, the time-sequential load information 1411 and configuration modification history 1413 are collated with each other (step 8080). If load is verified not to be maintained appropriately after modification of the system configuration, the load prediction rules 1412 are corrected based on the time-sequential load information 1411 and configuration modification history 1413 as well as the time-sequential input information 1220 (step 9090).

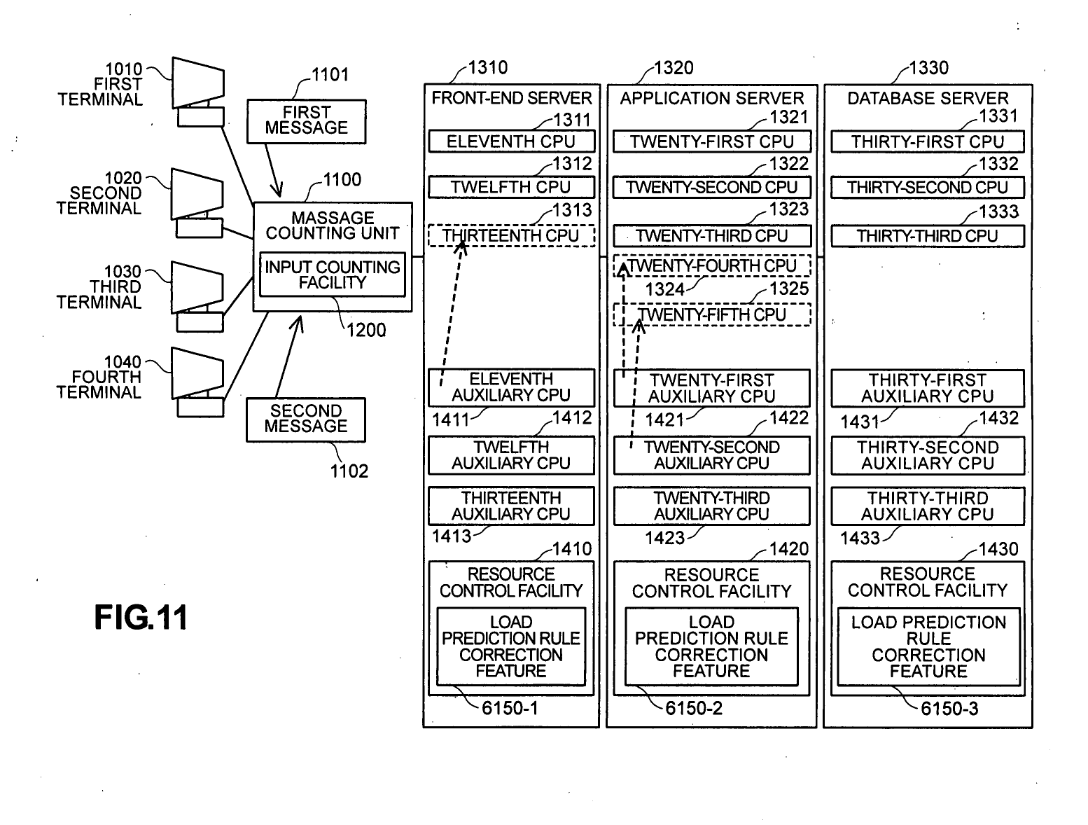

FIG. 11 is an explanatory diagram concerning a process to be followed when the load on CPUs increases along with an increase in the number of input messages. An eleventh CPU 1311 and a twelfth CPU 1312 are allocated as resources to the front-end server 1310. Eleventh to thirteenth auxiliary CPUs 1411 to 1413 are made available in case of an increase in load.

Likewise, twenty-first to twenty-third CPUs 1321 to 1323 are allocated to the application server 1320, and twenty-first to twenty-third auxiliary CPUs 1421 to 1423 are made available. Thirty-first to thirty-third CPUs 1331 to 1333 are allocated to the database server 1330, and thirty-first to thirty-third auxiliary CPUs 1431 to 1433 are made available.

A first message 1101 classified as the first kind of input “input 1” specified as a category in the input message classification table 300 is transmitted from each of the first to fourth terminals 1010 to 1040 to the input counting facility 1200 included in the message counting unit 1100. A second message 1102 classified as the second kind of input “input 2” is transmitted from the fourth terminal 1040 to the input counting facility 1200 included in the message counting unit 1100. The input counting facility 1200 records the numbers of arriving messages in the table 5010. The servers 1310, 1320, and 1330 execute message handling, and a transition of the load on CPUs is recorded in the CPU use rate table 4100.

Assume that the number of input messages of the second kind “Input 2” having arrived over the last one minute has increased to be larger by 30 messages than the number of input messages received over one minute before the last one minute.

Under the circumstances, the resource control facilities 1410 and 1420 included in the front-end server and application server receive information on a current situation from the input counting facility 1200. The load prediction rules 1412 and 1422 bring the conclusion that an increase in load occurs in the front-end server 1310 and application server 1320. Consequently, the number of CPUs to be allocated to the front-end server 1310 is increased by 1, and the number of CPUs to be allocated to the application server 1320 is increased by 2. Specifically, the eleventh auxiliary CPU 1411 included in the front-end server is activated as a thirteenth CPU 1313. The twenty-first and twenty-second auxiliary CPUs 1421 and 1422 included in the application server are activated as twenty-fourth and twenty-fifth CPUs 1324 and 1325 respectively.

Thereafter, if the fact that the load on the front-end server 1310 does not increase is verified a sufficient number of times, a load prediction rule correction feature 6150-1 included in the front-end server corrects the load prediction rules 1412 relevant to the front-end server 1310. Consequently, under the conditions presented in the foregoing case, the prediction that the load on CPUs allocated to the front-end server 1310 will increase will not be made.

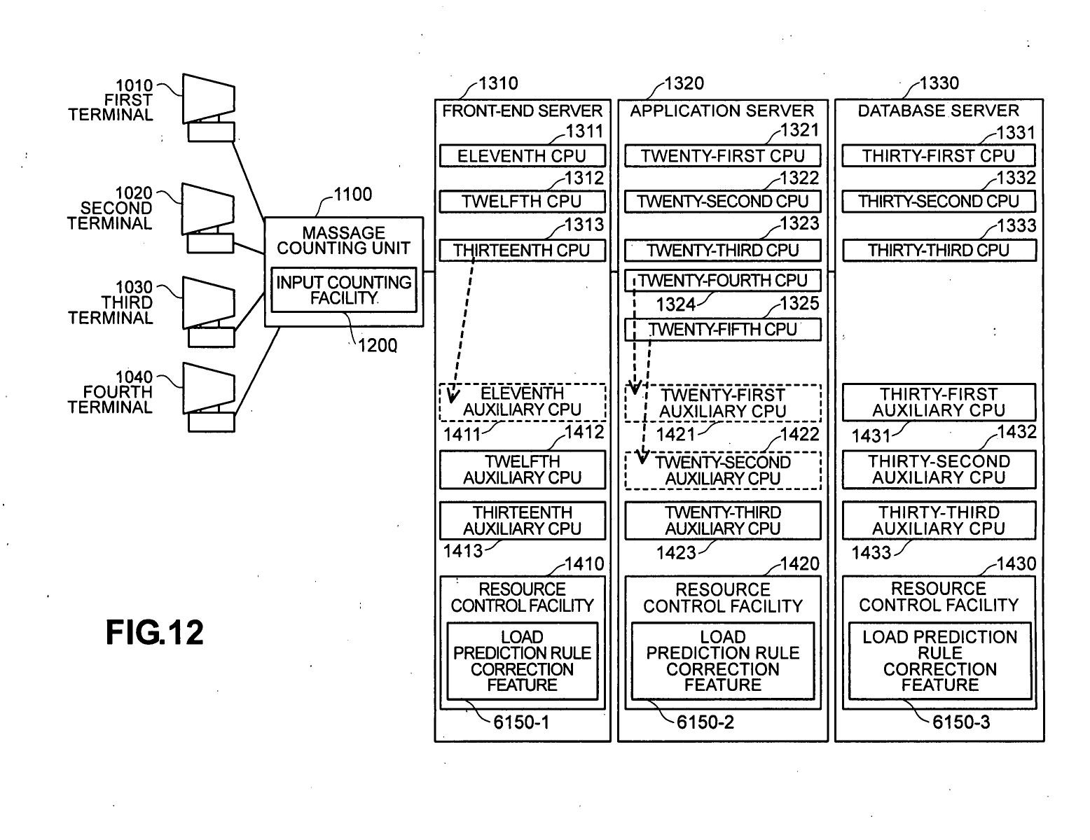

FIG. 12 is an explanatory diagram concerning a process to be followed when the load on CPUs decreases along with a decrease in the number of input messages. Assume that some time has elapsed since a temporary increase in the load on CPUs like the one described in conjunction with FIG. 11, and the loads on the front-end server 1310 and application server 1320 respectively have decreased to a level attained before the temporary increase.

The resource control facilities 1410 and 1420 receive information on a current situation from the input counting facility 1200. The load prediction rules 1412 and 1422 bring the conclusion that the load will decrease. Accordingly, the number of CPUs to be allocated to the front-end server 1310 is decreased by 1, and the number of CPUs to be allocated to the application server 1320 is decreased by 2. Specifically, the thirteenth CPU 1313 included in the front-end server is inactivated and put to standby as the eleventh auxiliary CPU 1411. Moreover, the twenty-fourth and twenty-fifth CPUs 1324 and 1325 included in the application server are inactivated and put to standby as the twenty-first and twenty-second auxiliary CPUs 1421 and 1422 respectively.

Thereafter, if an event that the load on the front-end server 1310 returns to the peak is observed some times, the load prediction rule correction feature 6150-1 corrects the load prediction rules 1412 relevant to the front-end server 1310. Thereafter, if the conditions presented in the case are met, the prediction that the load on CPUs will remain low and get stabilized will not be made.

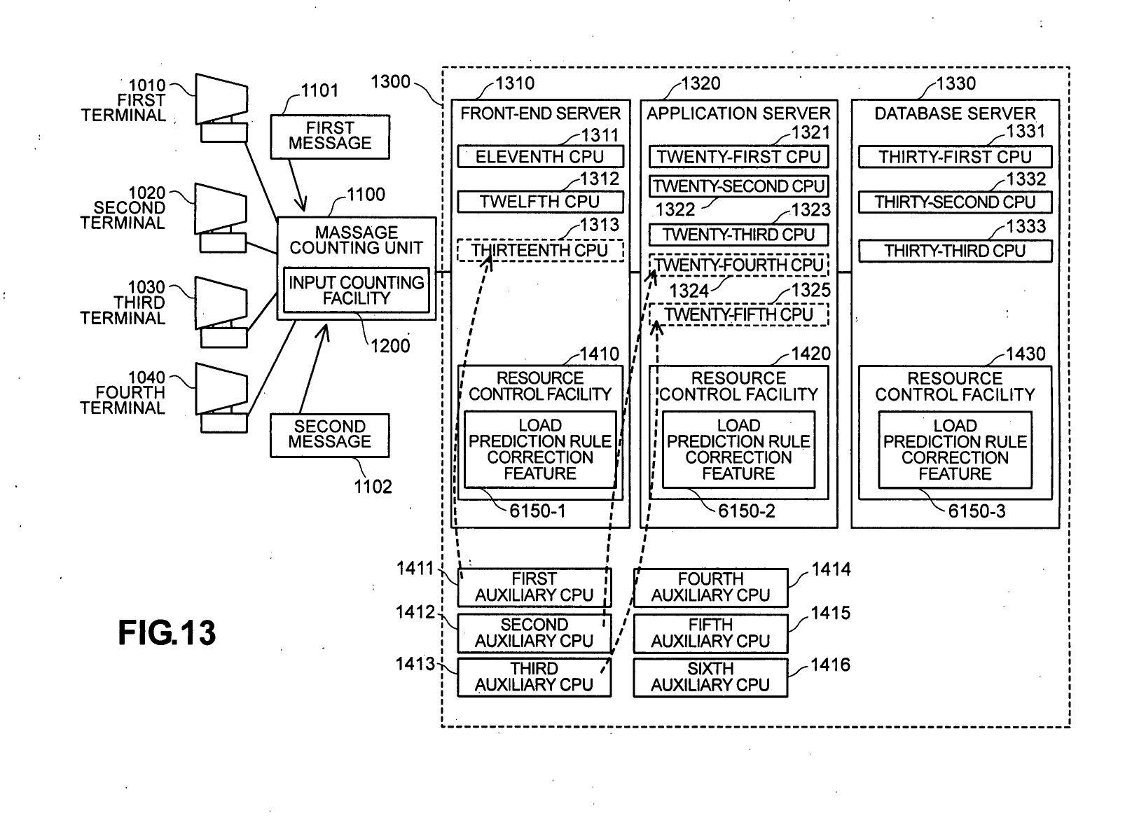

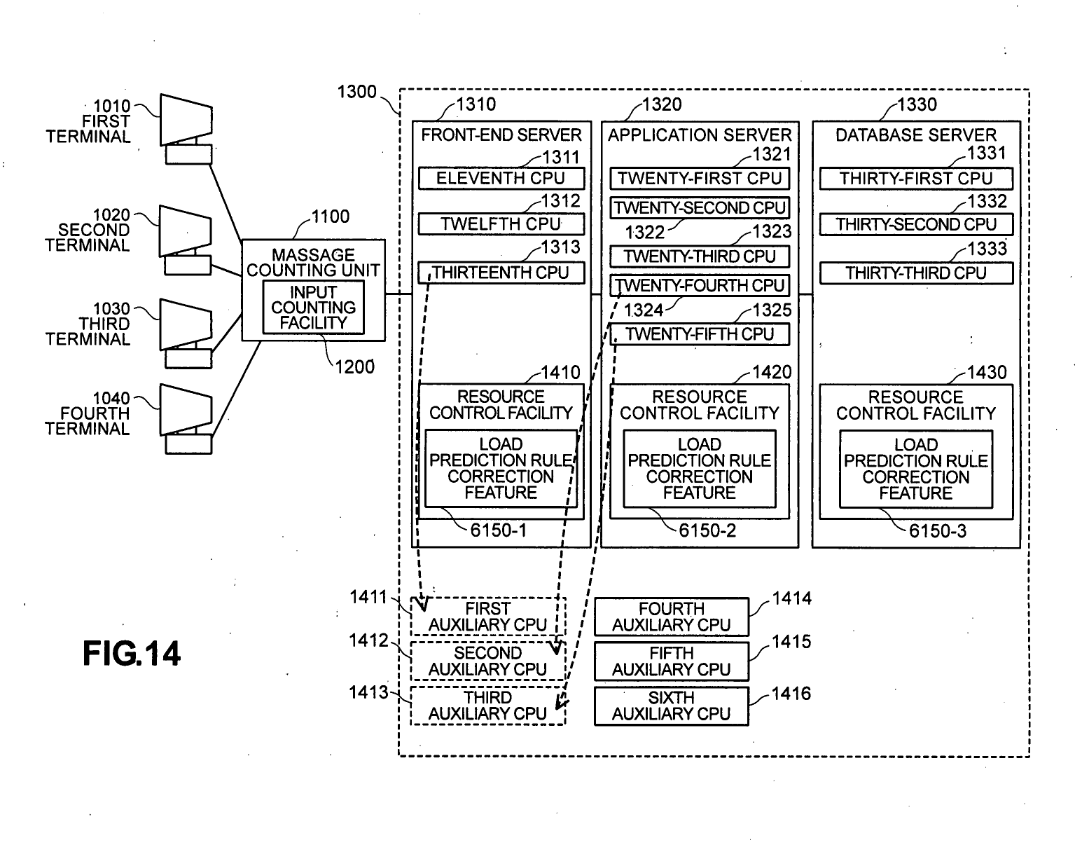

Next, referring to FIG. 13 and FIG. 14, a description will be made of a process to be followed in a configuration, in which one computer is divided into a plurality of logical computers, when the load on CPUs increases or decreases due to a variation in the number of input messages. In this case, similarly to the cases described in conjunction with FIG. 11 and FIG. 12, the front-end server 1310, application server 1320, and database server 1330 are formed as logical computers within one server 1300.

To begin with, FIG. 13 is concerned with a process to be followed in a configuration, in which one computer is divided into a plurality of logical computers, when the load on CPUs increases along with an increase in the number of input messages. The eleventh and twelfth CPUs 1311 and 1312 are allocated as resources to the front-end server 1310. The twenty-first to twenty-third CPUs 1321 to 1323 are allocated to the application server 1320, and the thirty-first to thirty-third CPUs 1331 to 1333 are allocated to the database server 1330. In the case shown in FIG. 11, the auxiliary CPUs are included in each of the servers. In the case shown in FIG. 13, auxiliary CPUs are managed as common auxiliary CPUs of first to sixth auxiliary CPUs 1411 to 1416 included in the server 1300.

Assume that the numbers of CPUs to be allocated to the front-end server 1310 and application server 1320 respectively are increased under the same preconditions as those for the case shown in FIG. 11. Consequently, in the case shown in FIG. 13, the first auxiliary CPU 1411 is allocated as the thirteenth CPU 1313 to the front-end server 1310, and the second and third auxiliary CPUs 1412 and 1413 are allocated as the twenty-fourth and twenty-fifth CPUs 1324 and 1325 to the application server 1320. The other processing steps are identical to those described in conjunction with FIG. 11.

FIG. 14 is an explanatory diagram concerning a process to be followed in a configuration, in which one computer is divided into a plurality of logical computers, when the load on CPUs decreases along with a decrease in the number of input messages. Incidentally, the system configuration shown in FIG. 14 is identical to that shown in FIG. 13.

Assume that the numbers of CPUs to be allocated to the front-end server 1310 and application server 1320 respectively are decreased under the same preconditions as those for the case shown in FIG. 12. Consequently, in the case shown in FIG. 14, the thirteenth CPU 1313 allocated to the front-end server 1310 is restored to the first auxiliary CPU 1411. The twenty-fourth and twenty-fifth CPUs 1324 and 1325 allocated to the application server 1320 are restored to the second and third auxiliary CPUs 1412 and 1413 respectively. The other processing steps are identical to those described in conjunction with FIG. 12.

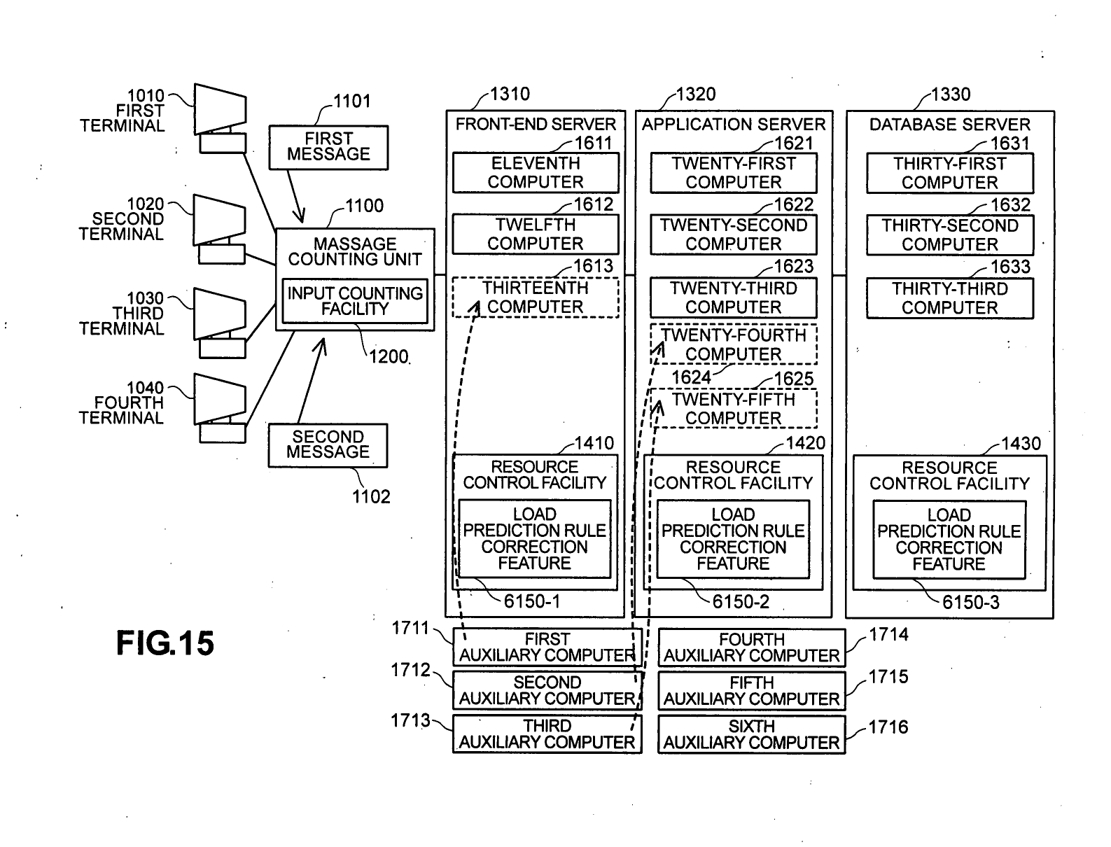

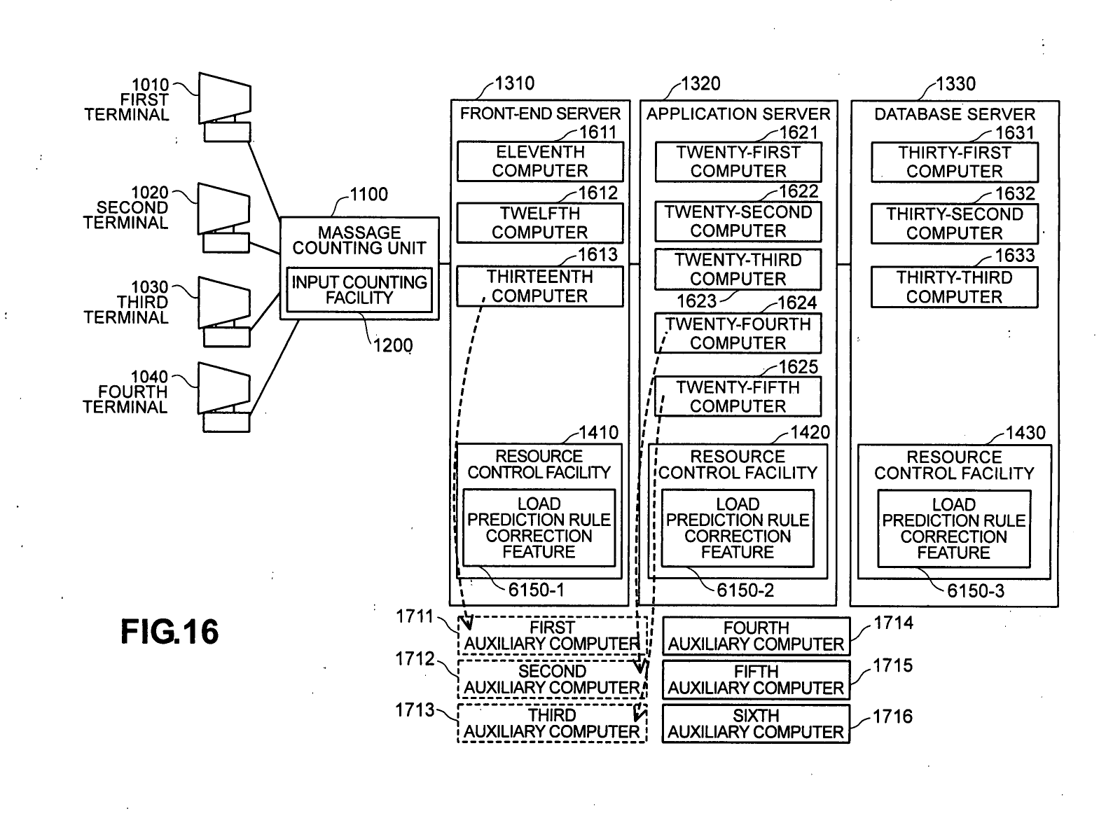

Next, referring to FIG. 15 and FIG. 16, a description will be made of a process to be followed in a computer system, which comprises a plurality of computers such as grid computers or blade servers when the load on CPUs increases or decreases along with a variation in the number of input messages.

FIG. 15 is concerned with a process to be followed in a computer system, which comprises a plurality of computers, when the load on CPUs increases along with an increase in the number of input messages. The computer system comprises a front-end server 1310, an application server 1320, a database server 1330, and first to sixth auxiliary computers 1711 to 1716. Eleventh to thirty-third computers 1611 and 1612, 1621 to 1623, and 1631 to 1633, and the first to sixth auxiliary computers 1711 to 1716 are provided in the form of a set of blade servers fitted on a single rack, or in the form of a set of servers interconnected over a network and realized with grid computers. The eleventh and twelfth computers 1611 and 1612 that include resources such as a CPU and a memory are allocated to the front-end server 1310. Likewise, the twenty-first to twenty-third computers 1621 to 1623 are allocated to the application server 1320. The thirty-first to thirty-third computers 1631 to 1633 are allocated to the database server 1330.

Assume that the numbers of CPUs to be allocated to the front-end server 1310 and application server 1320 are increased under the same preconditions as those described in conjunction with FIG. 11. In the case shown in FIG. 15, the first auxiliary computer 1711 is allocated as the thirteenth computer 1613 to the front-end server 1310. The second and third auxiliary computers 1712 and 1713 are allocated as the twenty-fourth and twenty-fifth computers 1624 and 1625 to the application server 1320. The other processing steps are identical to those described in conjunction with FIG. 11.

FIG. 16 is an explanatory diagram concerning a process to be followed in a computer system, which comprises a plurality of computers, when the load on CPUs decreases along with a decrease in the number of input messages. The system configuration shown in FIG. 16 is identical to that shown in FIG. 15.

Assume that the numbers of CPUs to be allocated to the front-end server 1310 and application server 1320 are decreased under the same preconditions as those described in conjunction with FIG. 12. In the case shown in FIG. 16, the thirteenth computer 1613 allocated to the front-end server 1310 is restored to the first auxiliary computer 1711. The twenty-fourth and twenty-fifth computers 1624 and 1625 allocated to the application server 1320 are restored to the second and third auxiliary computers 1712 and 1713. The other processing steps are identical to those performed in the case of FIG. 12.

Consequently, precision in predicting the load on a system improves. A service level provided for users and indicated with a response time of the system or the like can be reliably retained at a satisfactory level.

As described so far, according to the present embodiment, a computer system comprises a plurality of servers and acts in consideration of a variation in load. A receiving-side server predicts future load on the basis of the contents and kinds of messages received from terminals, the attributes of senders, the number of arriving messages or a variation in the number of arriving messages, and load prediction rules. The receiving-side server then preserves required computer resources. Thereafter, the receiving-side server receives and handles messages. At this time, the receiving-side server measures the load actually. imposed, compares the result of load prediction with a variation in the actually imposed load, and corrects the rules, which are used to predict load, according to the result of the comparison. Eventually, the precision in predicting load improves.

Since the present invention includes the aforesaid components, the present invention can provide a computer system capable of effectively allocating resources despite a variation in load, and retaining a service level, which is indicated with a response time or the like, at a predetermined value.

1. A computer system comprising:
a server that receives messages sent from respective terminals, performs handlings associated with the received messages, and reallocates resources according to a variation in load deriving from the reception of messages; and
a message counting unit that is connected to said server, classifies the messages received from the respective terminals on the basis of an input classification table, and transmits messages, which are classified into each category, as time-sequential input information, wherein:
said server predicts a minimum usage of each resource according to the time-sequential input information, time-sequential load information representing a change in load on each of recourses included in said server, and load prediction rules in which a predicted value of a variation in load occurring in said server in a predetermined time due to the reception of messages is recorded.

2. A computer system according to claim 1, wherein: said server predicts a minimum usage of each resource on the basis of the time-sequential input information, time-sequential load information representing a change in load on each resource, and load prediction rules in which a predicted value of a variation in load occurring in said server in a predetermined time due to the reception of messages is recorded; and the system configuration of said server is modified in compliance with the predicted usages of resources.

3. A computer system according to claim 2, wherein said server records a history of modifications of the system configuration.

4. A computer system according to claim 3, wherein said server compares the time-sequential load information with information contained in the system modification history so as to update information contained in the load prediction rules.

5. A computer system according to claim 1, wherein the message specifies a kind of message, an attribute of a sender, or an event attributable to the message.

6. A control method for computer systems in which messages are received from respective terminals, handlings associated with the received messages are performed, and resources included in a server are reallocated along with a variation in load deriving from the reception of messages, comprising the steps of:
classifying the messages received from the respective terminals on the basis of an input classification table, and transmitting messages, which are classified into each category, as time-sequential input information;
predicting a minimum usage of each resource according to the time-sequential input information, time-sequential load information representing a change in load on each resource, and load prediction rules in which a predicted value of a variation in load occurring in said server in a predetermined time due to the reception of messages is recorded; and
reallocating resources on the basis of the predicted usages.

7. A computer system control method according to claim 6, wherein said reallocating step includes a step of modifying the system configuration of said server in compliance with the usages of resources predicted based on the predicted value.

8. A computer system control method according to claim 7, wherein said reallocating step includes a step of recording a history of modifications of the system configuration.

9. A computer system control method according to claim 8, further comprising a step of comparing the time-sequential load information with information contained in the system modification history so as to update information contained in the load prediction rules.

10. A computer system control method according to claim 6, wherein the message specifies a kind of message, an attribute of a sender, or an event attributable to the message.
